(19) United States
(12) Patent Application Publication
(10) Pub. No.: US 2025/0190821 A1
(43) Pub. Date: Jun. 12, 2025

(54) KNOWLEDGE EXTRACTION APPARATUS AND KNOWLEDGE EXTRACTION METHOD

(71) Applicant: Hitachi, Ltd., Tokyo (JP)

(72) Inventor: Kazuo MUTO, Tokyo (JP)

(21) Appl. No.: 18/961,971

(22) Filed: Nov. 27, 2024

(30) Foreign Application Priority Data
Dec. 7, 2023 (JP) 2023-206812

(51) Int. Cl. G06N 5/022

(52) U.S. Cl. CPC G06N 5/022

(57) ABSTRACT

A sentence input unit that receives a case sentence that is a target of knowledge extraction from the outside and outputs the case sentence as target sentence data; a prompt generation unit that outputs a knowledge extraction prompt including ontology definition data, case data, the target sentence data, and a predetermined prompt template; a knowledge extraction control unit that accepts, as an input, the knowledge extraction prompt and knowledge extraction control setting data in which an extraction condition of the knowledge extraction is prescribed and outputs a knowledge extraction command to execute the knowledge extraction; a language model that accepts the knowledge extraction command as an input and outputs an extracted knowledge related to a knowledge extracted; and a knowledge verification unit that accepts the extracted knowledge as an input and verifies validity of the extracted knowledge are included.

### CROSS-REFERENCE TO RELATED APPLICATION

The present application claims priority from Japanese application JP2023-206812, filed on Dec. 7, 2023, the content of which is hereby incorporated by reference into this application.

### BACKGROUND OF THE INVENTION

### 1. Field of the Invention

The present invention relates to a knowledge extraction apparatus and a knowledge extraction method and is particularly appropriate for, for example, a knowledge extraction apparatus related to a technique for extracting knowledge from literatures such as patent literatures and academic papers.

### 2. Description of Related Art

Literatures such as patent literatures or academic papers describe knowledge based on latest search results. By utilizing the knowledge described in the literatures, it is possible to execute monitoring of research trends, analysis based on latest data, and the like. For example, in order to develop new materials, statistical models or the like for predicting characteristics of the new materials can be generated by utilizing knowledge such as experimental data described in the literatures such as patent literatures or academic papers.

Literatures such as patent literatures or academic papers often have unstructured data including natural language, diagrams, tables. Therefore, in order to utilize the literatures for data analysis or the like, it is necessary to extract knowledge from the literatures and convert the extracted knowledge into structured data such as table data. Tasks for the above-described extraction are often executed by labor. For example, there is a problem that it takes considerable time and labor since a required knowledge is extracted by reading and interpreting the literatures such as patent literatures and academic papers. Literatures such as patent literatures or academic papers are published daily, and thus it is not realistic to extract such literatures by labor.

In such a background, WO2021/156684 discloses a technique for extracting useful knowledge automatically from literatures using natural language processing. In the technique disclosed in WO2021/156684, required information is extracted from literatures based on a domain-specific natural language processing engine and a domain-specific ontology. Here, the ontology refers to a definition of a concept (class) that is to be extracted using natural language processing or a relationship (relation) or the like.

In the technique disclosed in WO2021/156684, it is necessary to prepare a natural language processing engine corresponding to the domain-specific ontology in advance. However, depending on a domain, it is not realistic to prepare a complete ontology in advance and it is often necessary to change the ontology after an operation starts. When the ontology is changed, it is necessary to change the natural language processing engine accordingly. In the natural language processing engine, a scheme such as a rule base or machine learning is used. When the ontology is changed, it is necessary to take countermeasures such as addition and re-examination of rules or generation and re-training of supervised data. Since data scientists or the like are required to take the countermeasures by labor, there is a problem that a countermeasure workload is significant.

### SUMMARY OF THE INVENTION

The present invention has been made in view of the foregoing circumstances and proposes a knowledge extraction apparatus and a knowledge extraction method capable of reducing a countermeasure workload in association with a change in an ontology without significant labor.

To solve the problem, according to an aspect of the present invention, a knowledge extraction apparatus includes: an ontology definition unit configured to receive definition of an ontology of a knowledge to be extracted from outside and output the definition of the ontology as ontology definition data; a case generation unit configured to accept the ontology definition data as an input, receive a combination of a case sentence and an extracted knowledge extracted from the case sentence as a case from the outside, and output the combination as case data; a sentence input unit configured to receive a case sentence that is a target of knowledge extraction from the outside and output the case sentence as target sentence data; a prompt generation unit configured to accept the ontology definition data, the case data, the target sentence data, and a predetermined prompt template as an input and output a knowledge extraction prompt including the ontology definition data, the case data, the target sentence data, and the predetermined prompt template; a knowledge extraction control unit configured to accept, as an input, the knowledge extraction prompt and knowledge extraction control setting data in which an extraction condition of the knowledge extraction is prescribed and output a knowledge extraction command to execute the knowledge extraction; a language model configured to accept the knowledge extraction command as an input and output an extracted knowledge related to a knowledge extracted; and a knowledge verification unit configured to accept the extracted knowledge as an input and verify validity of the extracted knowledge.

According to another aspect of the present invention, a knowledge extraction method includes: an ontology definition step in which an ontology definition unit receives definition of an ontology of a knowledge to be extracted from outside and outputs the definition of the ontology as ontology definition data; a case generation step in which a case generation unit accepts the ontology definition data as an input, receives a combination of a case sentence and an extracted knowledge extracted from the case sentence as a case from the outside, and output the combination as case data; a sentence input step in which a sentence input unit receives a case sentence that is a target of knowledge extraction from the outside and outputs the case sentence as target sentence data; a prompt generation step in which a prompt generation unit accepts the ontology definition data, the case data, the target sentence data, and a predetermined prompt template as an input and outputs a knowledge extraction prompt including the ontology definition data, the case data, the target sentence data, and the predetermined prompt template; a knowledge extraction control step in which a knowledge extraction control unit accepts, as an input, the knowledge extraction prompt and knowledge extraction control setting data in which an extraction condition of the knowledge extraction is prescribed and outputs a knowledge extraction command to execute the knowledge extraction; and a knowledge verification step in which a knowledge verification unit accepts the knowledge extraction command as an input using a language model, and outputs an extracted knowledge related to a knowledge extracted, and verifies validity of the extracted knowledge.

According to the present invention, it is possible to reduce a countermeasure workload in association with a change in an ontology without significant labor.

### BRIEF DESCRIPTION OF THE DRAWINGS

FIG. 1 is a system configuration diagram illustrating an example of a basic configuration of a knowledge extraction apparatus according to a first embodiment;

FIG. 2 is a diagram illustrating an example of a flow of data associated with a process executed by the knowledge extraction apparatus according to the first embodiment;

FIG. 3 is a diagram illustrating a configuration example of a prompt generation unit;

FIG. 4 is a diagram illustrating an example of a class definition screen;

FIG. 5 is a diagram illustrating an example of a screen on which classes of an ontology are defined;

FIG. 6 is a diagram illustrating an example of a screen on which a relation between the classes of the ontology is defined;

FIG. 7 is a flowchart illustrating an example of a procedure of a knowledge extraction process using the knowledge extraction apparatus;

FIG. 8 is a diagram illustrating an example of a knowledge extraction prompt;

FIG. 9 is a diagram illustrating an example of ontology definition data;

FIG. 10 is a diagram illustrating an example of a result of verifying an extracted knowledge graph using the ontology definition data illustrated in FIG. 9;

FIG. 11 is a system configuration diagram illustrating an example of a basic configuration of a knowledge extraction apparatus according to a second embodiment;

FIG. 12 is a diagram illustrating an example of a flow of data according to the second embodiment;

FIG. 13 is a flowchart illustrating an operation example of the knowledge extraction apparatus according to the second embodiment; and

FIG. 14 is a diagram illustrating an example of a knowledge correction screen.

### DESCRIPTION OF EMBODIMENTS

Hereinafter, embodiments of the present invention will be described in detail with reference to the drawings.

### (1) First Embodiment

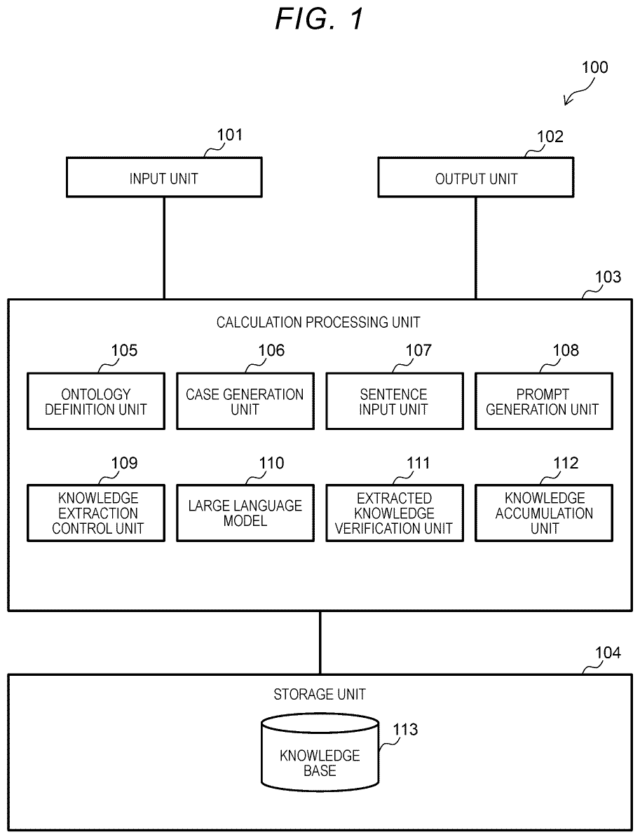

FIG. 1 is a system configuration diagram illustrating an example of a basic configuration of a knowledge extraction apparatus 100 according to a first embodiment. The knowledge extraction apparatus 100 includes an input unit 101, an output unit 102, a calculation processing unit 103, and a storage unit 104.

The input unit 101 is any of various input devices such as a keyboard, a mouse, and a touch panel. The input unit 101 is used when a user inputs any data in the knowledge extraction apparatus 100.

The output unit 102 is an output device such as a display device. The output unit 102 displays a screen for an interactive process with the calculation processing unit 103.

The calculation processing unit 103 is, for example, a central processing unit (CPU). The calculation processing unit 103 executes information processing in the knowledge extraction apparatus 100. The calculation processing unit 103 includes an ontology definition unit 105, a case generation unit 106, a sentence input unit 107, a prompt generation unit 108, a knowledge extraction control unit 109, a large language model 110, an extracted knowledge verification unit 111, and a knowledge accumulation unit 112.

The storage unit 104 is a storage unit such as a hard disk drive (HDD) or a solid state drive (SSD). The storage unit 104 stores a knowledge base 113 to be described below or the like.

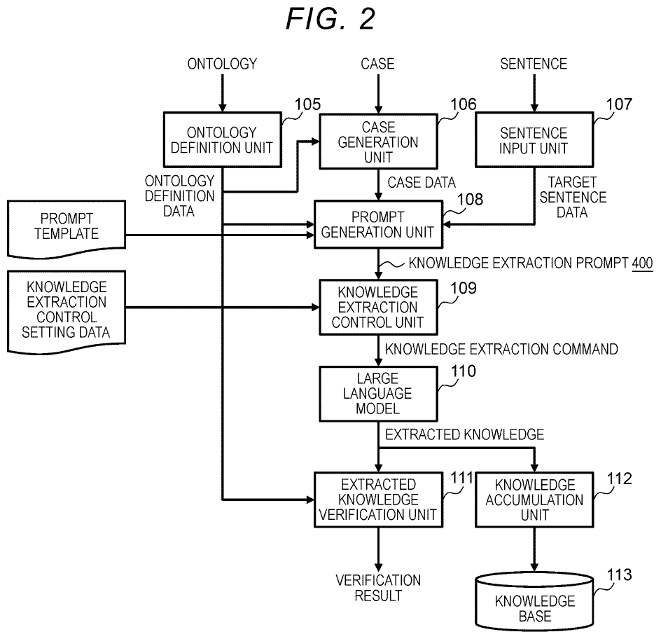

Next, a process (knowledge extraction method) executed by the knowledge extraction apparatus 100 and input/output data of the process according to the first embodiment will be described. FIG. 2 is a diagram illustrating an example of a flow of data associated with the process executed by the knowledge extraction apparatus 100 according to the first embodiment.

The ontology definition unit 105 receives definition of an ontology of a knowledge to be extracted from the outside and outputs the definition of the ontology as ontology definition data. Here, the ontology refers to definition of a concept (class) to be extracted using natural language processing or a relationship (a relation, a property, or an instance) thereof. An example of a screen displayed on the output unit 102 for the ontology definition unit 105 to receive the definition of the ontology from the outside will be described below.

The case generation unit 106 accepts the ontology definition data output by the ontology definition unit 105 as an input, receives a combination of a case sentence and an extracted knowledge extracted from the case sentence as a case from the outside, and outputs the combination as case data. That is, the case data includes the case sentence and the extracted knowledge. On the other hand, the extracted knowledge is a knowledge extracted from the case sentence. The extracted knowledge is expressed in, for example, a form of an extracted knowledge graph. The extracted knowledge graph intrinsically follows an ontology defined with the ontology definition data. However, since there are otherwise cases, according to the present embodiment, as will be described below, validity of the extracted knowledge is verified based on the extracted knowledge graph.

The sentence input unit 107 receives a case sentence that is a target for extracting a knowledge from the case data (hereinafter referred to as “knowledge extraction”) from the outside and outputs the case sentence as target sentence data. In the reception of the sentence from the outside, a character string may be directly received, or a file in which a target sentence is described, a directory in which the file is stored, and the like may be designated and the file may be received.

The prompt generation unit 108 accepts the ontology definition data, the case data, the target sentence data, and a predetermined prompt template as an input and outputs a knowledge extraction prompt including the ontology definition data, the case data, the target sentence data, and the predetermined prompt template. Here, a knowledge extraction command or the like is described in the prompt template. The details of the prompt generation unit 108 will be described below.

The knowledge extraction control unit 109 accepts the above-described knowledge extraction prompt and knowledge extraction control setting data in which an extraction condition of the knowledge extraction is prescribed and outputs a command to execute the knowledge extraction (hereinafter referred to as “knowledge extraction command”). Here, the knowledge extraction control setting data includes, for example, extraction conditions such as a type and a parameter of the large language model 110 to be used and the number of trials of the knowledge extraction. The knowledge extraction command is a command formatted in conformity with a large language model using the knowledge extraction prompt and the knowledge extraction control setting data. The details of the knowledge extraction prompt will be described below.

The large language model 110 is an example of a language model and accepts the knowledge extraction command as an input and outputs a knowledge extracted (hereinafter referred to as “extracted knowledge”). The large language model 110 is a machine learning model trained so that appropriate text is output with respect to an input when an instruction to urge any output or information is input as text. The extracted knowledge graph is a knowledge graph extracted from a target case sentence and is originally supposed to follow the ontology defined with the ontology definition data.

The extracted knowledge verification unit 111 that is an example of a knowledge verification unit, and accepts extracted knowledge as an input and verifies validity of the extracted knowledge. More specifically, the extracted knowledge verification unit 111 accepts the extracted knowledge as an input, generates, for example, an extracted knowledge graph related to the extracted knowledge, and verifies validity of the extracted knowledge. Further, the extracted knowledge verification unit 111 accepts the ontology definition data as an input and determines, based on the extracted knowledge graph, whether the input extracted knowledge is valid in view of definition content by the ontology definition data. The extracted knowledge verification unit 111 outputs the verification result. The verification result includes at least an identifier for determining whether the extracted knowledge is valid. When the extracted knowledge is not valid, the extracted knowledge verification unit 111 may include the reason why the extracted knowledge is not valid in a verification result to be output. In the embodiment, in the determination of whether the extracted knowledge is valid, a predetermined rule, a statistical scheme, or the like can be utilized. For example, the extracted knowledge can be verified according to whether the knowledge follows the ontology definition data. The details of the ontology definition data will be described below.

When the extracted knowledge verification unit 111 determines that the input extracted knowledge is valid, the knowledge accumulation unit 112 executes accumulation control of the extracted knowledge in the storage unit 104 including a knowledge base 113 in which the extracted knowledge is accumulated. The knowledge base 113 is a graph database or the like. When the input extracted knowledge is determined to be valid, the extracted knowledge verification unit 111 accumulates the extracted knowledge in the knowledge base 113.

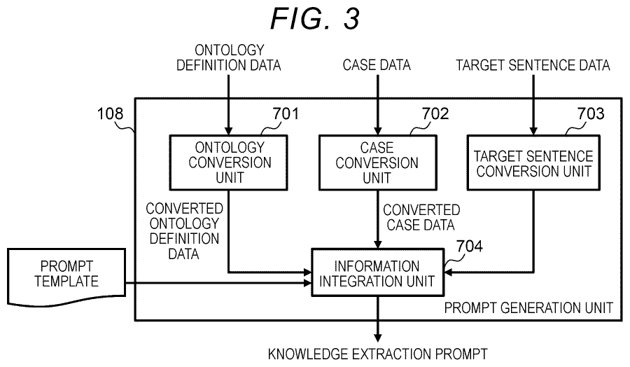

FIG. 3 is a diagram illustrating a configuration example of the prompt generation unit 108. The prompt generation unit 108 includes an ontology conversion unit 701, a case conversion unit 702, and a target sentence conversion unit 703 as examples of a conversion unit that converts data so that the large language model 110 easily processes the data. The prompt generation unit 108 further includes an information integration unit 704.

The ontology conversion unit 701 accepts the ontology definition data as an input and outputs the converted ontology definition data. The converted ontology definition data is data converted so that the large language model 110 can easily process the ontology definition data and is described in, for example, the format of a a turtle of a resource description framework.

The case conversion unit 702 accepts the case data as an input and outputs the converted case data. The converted case data is formed by a converted case sentence and converted case extracted knowledge. The converted case sentence is a sentence obtained by executing a normalization process or the like of removing an unnecessary character string on the case sentence of the case data. The converted case extracted knowledge graph is data converted so that the large language model 110 can easily process the case extracted knowledge and is described in, for example, the format of a a turtle of a resource description framework.

The target sentence conversion unit 703 accepts the target sentence data as an input and outputs the converted target sentence data. The converted target sentence data is a sentence obtained by executing a normalization process or the like of removing an unnecessary character string on the target sentence data.

The information integration unit 704 integrates the converted ontology definition data, the converted case data, the converted target sentence data, and the prompt template to generate a knowledge extraction prompt, and outputs the knowledge extraction prompt. The details of the knowledge extraction prompt will be described below.

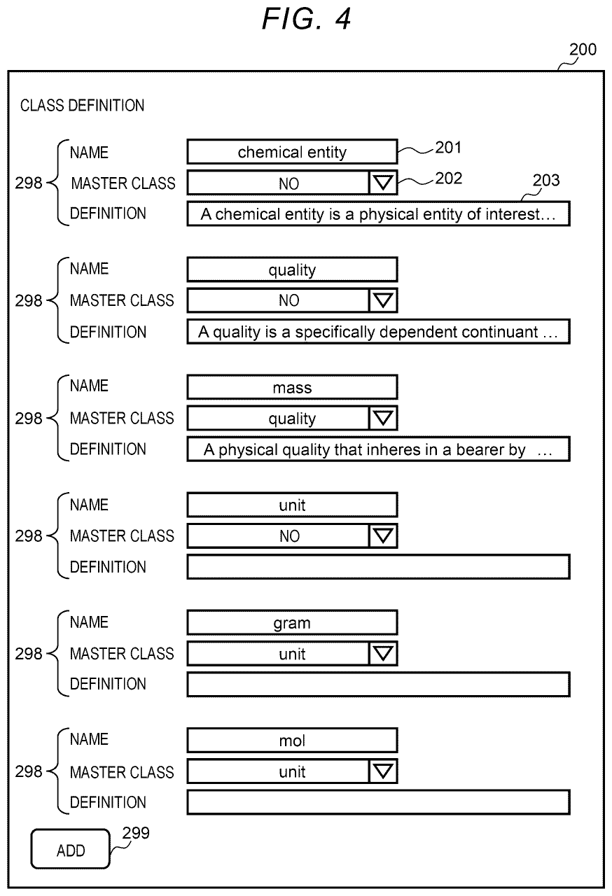

FIG. 4 is a diagram illustrating an example of a class definition screen 200. The class definition screen 200 is a screen displayed on the output unit 102 and includes a plurality of class definition input fields 298 for inputting definition of each class (hereinafter referred to as “class definition”) and an addition button 299.

Each class definition input field 298 has a name input field 201, a master class input field 202, and a definition input field 203 for inputting definition. The name input field 201 is an input field for inputting a name of a class to be registered. The master class input field 202 is an input field for inputting a master class superordinate to the class input (registered) in the name input field 201. The definition input field 203 is an input field for inputting definition of each class.

The addition button 299 is a button for executing an operation of registering each input content of each class definition input field 298 in the knowledge base 113.

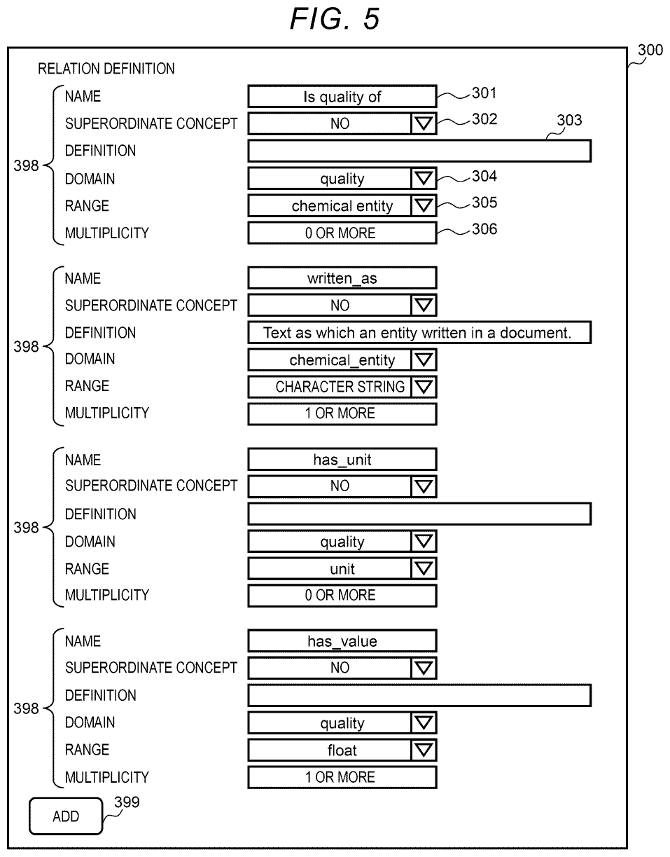

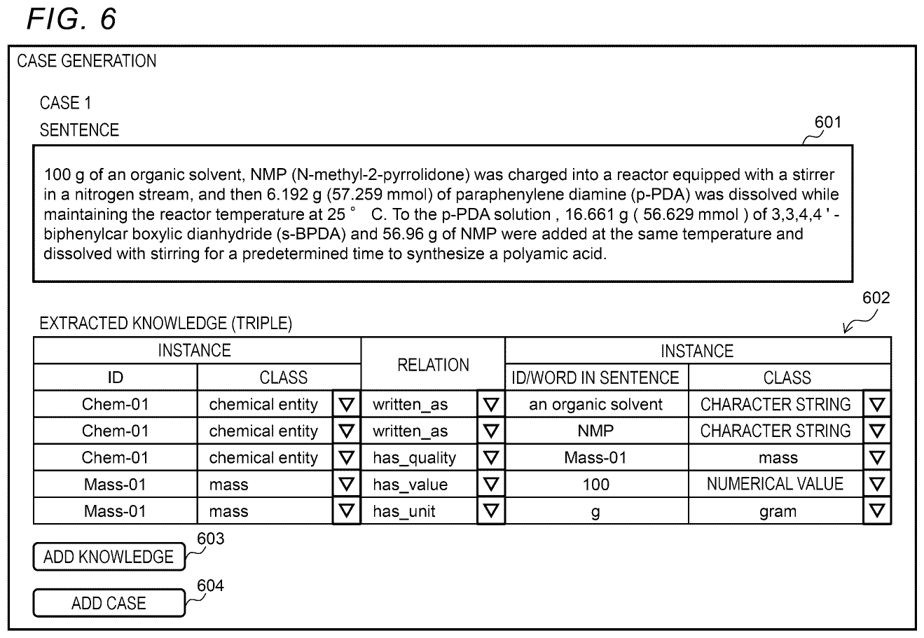

FIGS. 5 and 6 are diagrams illustrating examples of screens displayed in the output unit 102 for the ontology definition unit 105 to receive ontology definition from the outside. FIG. 5 is a diagram illustrating an example of a screen on which classes of an ontology are defined. The user can input names of classes, a master class, definition, and the like through the screen. FIG. 6 illustrates an example of a screen on which a relation between the classes of the ontology is defined. The user can define a name of a relation or an inherited superordinate concept, definition, domain, range, and the like through the screen.

FIG. 5 is a diagram illustrating an example of a relation definition screen 300. The relation definition screen 300 is a screen displayed on the output unit 102 and includes, for example a plurality of relation definition input fields 398 for inputting definition related to a relation between a plurality of classes (hereinafter referred to as “relation definition”) and an addition button 399.

Each relation definition input field 398 has a name input field 301, a superordinate input field 302, a definition input field 303 for inputting definition, a domain input field 304, a range input field 305, and a multiplicity input field 306.

The name input field 301 is an input field for a name of each relation definition. The superordinate input field 302 is an input field for inputting a superordinate concept of a relation definition of a name input to the name input field 301. The definition input field 303 is an input field for inputting definition.

The domain input field 304 is, for example, an input field for inputting a domain such as “quality”, “chemical entity”, or “quality”. The range input field 305 is, for example, an input field for inputting a range such as a character string, “unit”, “float (numerical value)”, or “chemical entity”. The multiplicity input field 306 is an input field for multiplicity indicating the extent of multiple allowance of definition.

The addition button 399 is a button for executing an operation of registering each input content of each relation definition input field 398 in the knowledge base 113.

FIG. 6 illustrates an example of a case generation screen displayed on the output unit 102 for the case generation unit 106 to receive a case from the outside. The case generation screen has a case sentence input unit 601, a case extracted knowledge input unit 602, a knowledge addition button 603, and a case addition button 604.

The user can input a case sentence to the case sentence input unit 601, input case extracted knowledge to the case extracted knowledge input unit 602, and presses the case addition button 604 to register content of both the inputs as a set in the knowledge base 113. The user can also input extracted knowledge to the case extracted knowledge input unit 602 and press the knowledge addition button 603 to register only the extracted knowledge to the knowledge base 113.

When the case extracted knowledge is input, the case extracted knowledge may be input in a triple format formed by three elements of a set of related instances and a relation between the instances. At this time, the user may be allowed to select a relation or classes of instances defined with the ontology definition data in a pull-down menu format or the like.

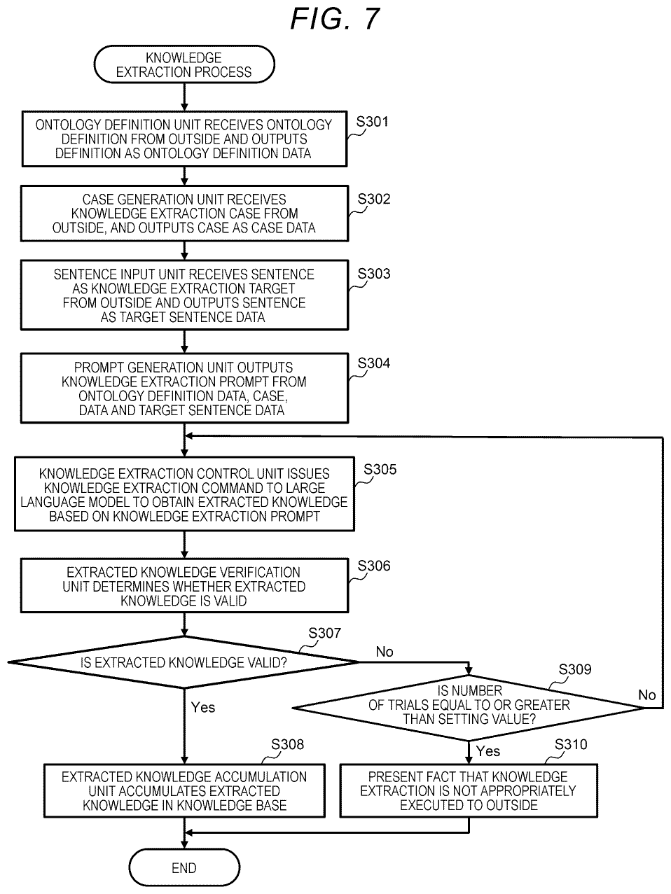

The knowledge extraction apparatus 100 according to the first embodiment has the above-described configuration. Next, an operation example will be described. FIG. 7 is a flowchart illustrating an example of a procedure of a knowledge extraction process using the knowledge extraction apparatus 100.

First, an overview of the knowledge extraction method using the knowledge extraction apparatus 100 will be described. The knowledge extraction method includes: an ontology definition step in which the ontology definition unit 105 receives definition of an ontology of a knowledge to be extracted from outside and outputs the definition of the ontology as ontology definition data; a case generation step in which the case generation unit 106 accepts the ontology definition data as an input, receives a combination of a case sentence and an extracted knowledge extracted from the case sentence as a case from the outside, and output the combination as case data; a sentence input step in which the sentence input unit 107 receives a case sentence that is a target of knowledge extraction from the outside and outputs the case sentence as target sentence data; a prompt generation step in which the prompt generation unit 108 accepts the ontology definition data, the case data, the target sentence data, and a predetermined prompt template as an input and outputs a knowledge extraction prompt including the ontology definition data, the case data, the target sentence data, and the predetermined prompt template; a knowledge extraction control step in which the knowledge extraction control unit 109 accepts, as an input, the knowledge extraction prompt and knowledge extraction control setting data in which an extraction condition of the knowledge extraction is prescribed and outputs a knowledge extraction command to execute the knowledge extraction; and a knowledge verification step in which the extracted knowledge verification unit 111 accepts the knowledge extraction command as an input using the large language model 110, and outputs an extracted knowledge related to a knowledge extracted, generates an extracted knowledge graph related to the extracted knowledge and verifies validity of the extracted knowledge. More specifically, the knowledge extraction apparatus 100 operates as follows.

The ontology definition unit 105 receives ontology definition from the outside and outputs the ontology definition data (step S301). The case generation unit 106 accepts the ontology definition data as an input, receives a case including a case sentence and the extracted knowledge from the outside, and outputs the case as case data (step S302).

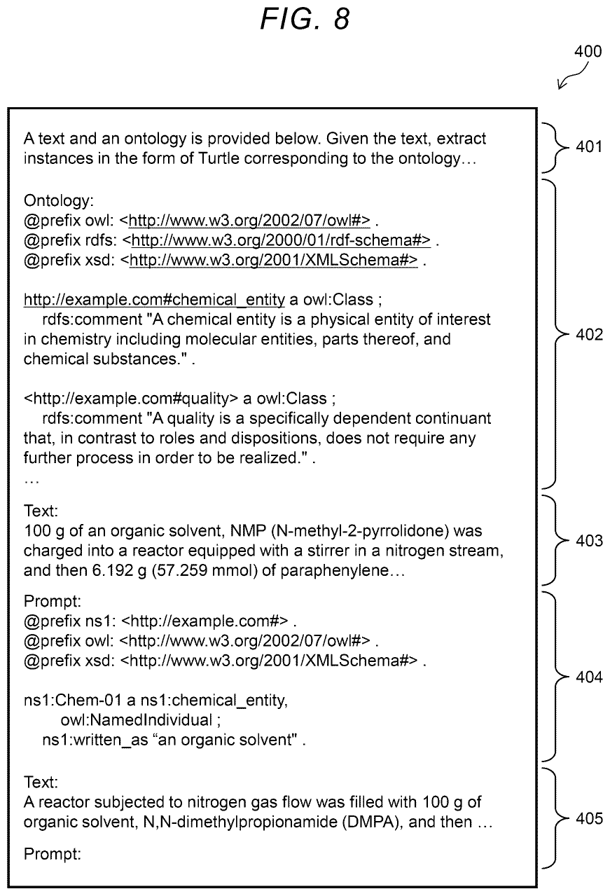

The sentence input unit 107 receives a target sentence from the outside and outputs the target sentence as target sentence data (step S303). The prompt generation unit 108 outputs a knowledge extraction prompt to be described below from the ontology definition data, the case data, the target sentence data (step S304). The details of the knowledge extraction prompt will be described below (see FIG. 8).

The knowledge extraction control unit 109 issues a knowledge extraction command to the large language model 110 to obtain extracted knowledge based on the knowledge extraction prompt (step S305). As will be described in detail, the extracted knowledge verification unit 111 verifies validity of the extracted knowledge, for example, confirms whether the extracted knowledge is in an appropriate style (step S306) and outputs a verification result. The details of verification of validity of extracted knowledge will be described in detail.

Based on a result of the verification related to the validity of the extracted knowledge, the extracted knowledge verification unit 111 determines whether the extracted knowledge is valid (step S307). When the valid extracted knowledge is obtained, the knowledge accumulation unit 112 stores the extracted knowledge in the knowledge base 113 and ends the process (step S308).

Conversely, when the valid extracted knowledge is not obtained, the knowledge extraction control unit 109 determines whether the number of trials of the knowledge extraction is equal to or greater than the number of trials defined with the knowledge extraction control setting data (step S309).

When the number of trials of the knowledge extraction is equal to or greater than the number of trials, the knowledge extraction control unit 109 issues a knowledge extraction command to the large language model 110 and obtains the extracted knowledge graph again, as described above (step S305). At this time, parameters of the large language model 110 may be changed or the verification result may be added to the knowledge extraction command.

Conversely, when the number of trails of the knowledge extraction is equal to or greater than the number of trials, the knowledge extraction control unit 109 presents the fact that the knowledge extraction is not appropriately executed to the outside, and then the process ends (step S310).

FIG. 8 is a diagram illustrating an example of a knowledge extraction prompt 400. In the knowledge extraction prompt 400, a knowledge extraction command 401, the converted ontology 402, the converted case sentence 403, the converted case extracted knowledge 404, the converted sentence data 405, and the like are described as text data.

The knowledge extraction command 401 corresponds to a prompt template and is a command to extract a knowledge. In the knowledge extraction prompt 400, the knowledge extraction command 401, the converted ontology 402, the converted case sentence 403, the converted case extracted knowledge 404, and the converted sentence data 405 are described in this order from the beginning of the text data.

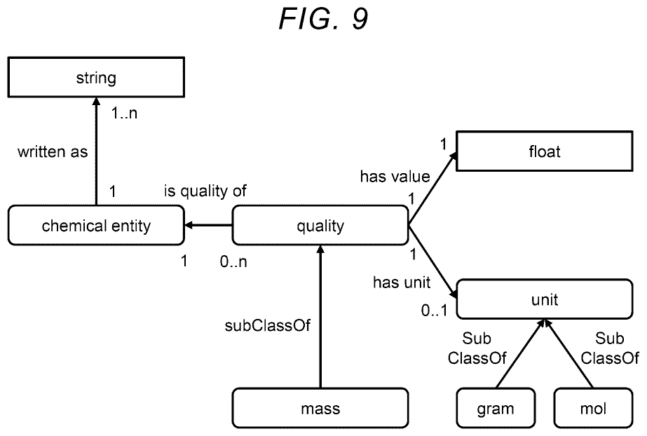

FIG. 9 is a diagram illustrating an example of ontology definition data. In the illustrated example, classes “chemical entity”, “quality”, “unit”, “mass”, “unit”, “gram”, and “mol” are defined. The class “mass” is defined as a sub-class inherited from the class “quality” and the classes “gram” and “mol” are defined as sub-classes inherited from the class “unit”.

Further, it can be understood that the class “chemical entity” is connected to one or more character strings (step String) by a property such as “written as” and is associated with 0 or more class “quality” by a property such as “has quality”, and the class “quality” is associated with one numerical value (float) by a property such as “has value” and is associated with 0 or more and one or less class “unit” by a property such as “has unit”.

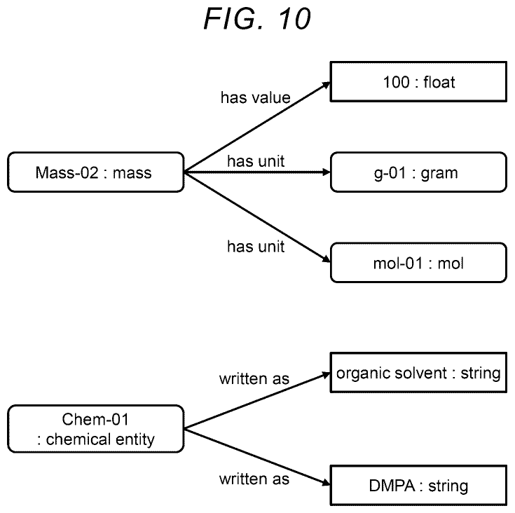

FIG. 10 is a diagram illustrating an example of a result of verifying an extracted knowledge graph using the ontology definition data illustrated in FIG. 9. In the illustrated example, an example of a result of verification is shown in content of definition based on the ontology definition data illustrated in FIG. 9 with regard to the extracted knowledge graph extracted from a sentence such as “ . . . nitrogen gas flow was filled with 100 g of organic solvent, N, N-dimethylpropionamide (DMPA), . . . ” that is an example of target sentence data.

In the embodiment, the ontology definition data includes at least one class that is an element forming extracted knowledge and a property indicating an attribute to be taken by the class. The extracted knowledge verification unit 111 verifies validity of the extracted knowledge based on whether the class is consistent with the property.

In the illustrated example, “Mass-01” is extracted as an instance of the class “mass”, a numerical value class “100” is associated by a property such as “has value”, and two classes of “gram” and “mol” are associated by a property such as “has unit”.

For example, “Mass-01” that is an instance of the class “mass” should be associated with 0 or more or one or less class “unit” by the property “has not” when the instance conforms with the ontology definition data illustrated in FIG. 9. However, in the extracted knowledge graph illustrated in FIG. 10, “Mass-01” is associated with two classes “unit” (“g-01: gram” and “mol-01: mol”) and is inconsistent with the ontology definition data.

In the embodiment, the ontology definition data includes at least one class that is an element forming extracted knowledge and an instance to correspond to the class. The extracted knowledge verification unit 111 verifies validity of the extracted knowledge according to whether the class corresponds to the instance.

For example, “Mass-01” that is an instance of “mass” should be associated with an instance of “chemical entity” when the instance conforms with the ontology definition data illustrated in FIG. 9. However, in the extracted knowledge graph illustrated in FIG. 10, “Mass-01” is not associated the instance of “chemical entity” and is inconsistent with the ontology definition data.

For example, based on the consistency with the ontology definition data and the like, as described above, the extracted knowledge verification unit 111 determines that the extracted knowledge is valid when there is no inconsistency, and determines that the extracted knowledge is not valid when there is inconsistency. As described above, the extracted knowledge verification unit 111 outputs the verification result to the output unit 102.

The knowledge extraction apparatus 100 according to the embodiment includes: the ontology definition unit 105 that receives definition of an ontology of a knowledge to be extracted from outside and outputs the definition of the ontology as ontology definition data; the case generation unit 106 that accepts the ontology definition data as an input, receives a combination of a case sentence and an extracted knowledge extracted from the case sentence as a case from the outside, and outputs the combination as case data; the sentence input unit 107 that receives a case sentence that is a target of knowledge extraction from the outside and outputs the case sentence as target sentence data; the prompt generation unit 108 that accepts the ontology definition data, the case data, the target sentence data, and a predetermined prompt template as an input and outputs a knowledge extraction prompt 400 including the ontology definition data, the case data, the target sentence data, and the predetermined prompt template; the knowledge extraction control unit 109 that accepts, as an input, the knowledge extraction prompt 400 and knowledge extraction control setting data in which an extraction condition of the knowledge extraction is prescribed and outputs a knowledge extraction command to execute the knowledge extraction; the large language model 110 that accepts the knowledge extraction command as an input and outputs an extracted knowledge related to a knowledge extracted; and the extracted knowledge verification unit 111 that accepts the extracted knowledge as an input and verifies validity of the extracted knowledge.

In this way, the knowledge can be extracted by generating a small number of cases and the ontology definition on a user side without significant labor, it is possible to reduce a countermeasure workload in association with a change in an ontology.

In the embodiment, the extracted knowledge verification unit 111 generates an extracted knowledge graph related to the extracted knowledge and verifies the validity of the extracted knowledge. In this way, it is possible to verify the validity of the extracted knowledge objectively by the extracted knowledge graph.

In the embodiment, based on the extracted knowledge graph, the extracted knowledge verification unit 111 determines whether the input extracted knowledge is valid in view of definition content by the ontology definition data. In this way, it is possible to verify whether the extracted knowledge is valid objectively based on the ontology defined in the ontology definition data.

In the embodiment, the extracted knowledge verification unit 111 outputs a verification result of the validity of the extracted knowledge. In this way, it is possible to determine the validity of the extracted knowledge objectively based on the output verification result.

The knowledge extraction apparatus 100 according to the embodiment includes the storage unit 104 including the knowledge base 113 in which the extracted knowledge is accumulated when the extracted knowledge verification unit 111 determines that the input extracted knowledge is valid. In this way, it is possible to accumulate the extracted knowledge determined to be valid.

In the embodiment, the prompt generation unit 108 includes a conversion unit (the ontology conversion unit 701, the case conversion unit 702, and the target sentence conversion unit 703) that converts data so that the large language model 110 easily processes the data, and the information integration unit 704 that integrates the ontology definition data, the case data, the target sentence data, and the prompt template to generate the knowledge extraction prompt 400. In this way, it is possible to optimize the process using the large language model 110.

In the embodiment, the ontology definition data includes at least one class that is an element included in the extracted knowledge and a property indicating an attribute to be taken by the class. The extracted knowledge verification unit 111 verifies validity of the extracted knowledge in accordance with whether the class is consistent with the property. In this way, when the class and the property are set in advance in the ontology definition data, the validity of the extracted knowledge can be determined accurately according to whether the class corresponds to the property based on the ontology definition data.

In the embodiment, the ontology definition data includes at least one class that is an element included in the extracted knowledge and an instance corresponding to the class. The extracted knowledge verification unit 111 verifies validity of the extracted knowledge in accordance with whether the class corresponds to the instance. In this way, when the class and the instance are set in advance in the ontology definition data, the validity of the extracted knowledge can be determined accurately according to whether the class corresponds to the instance based on the ontology definition data.

### (2) Second Embodiment

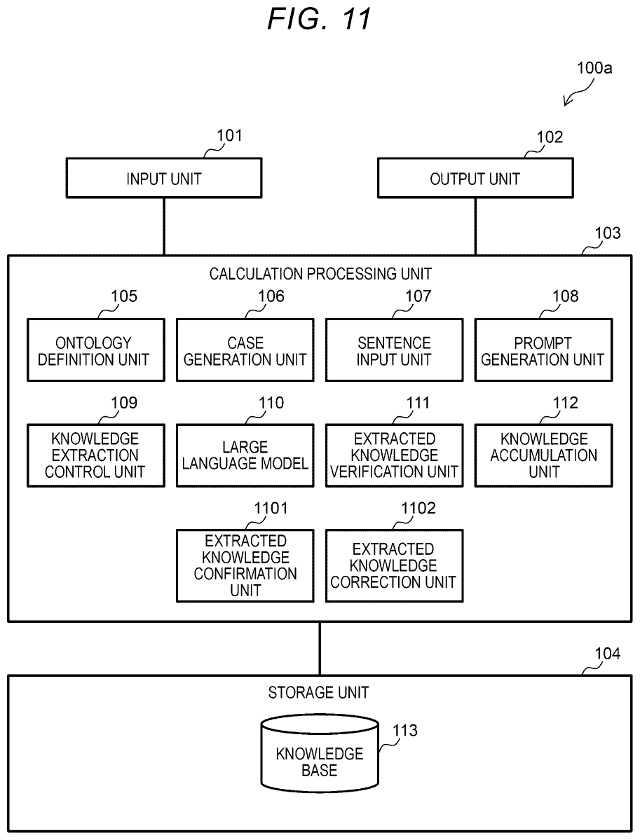

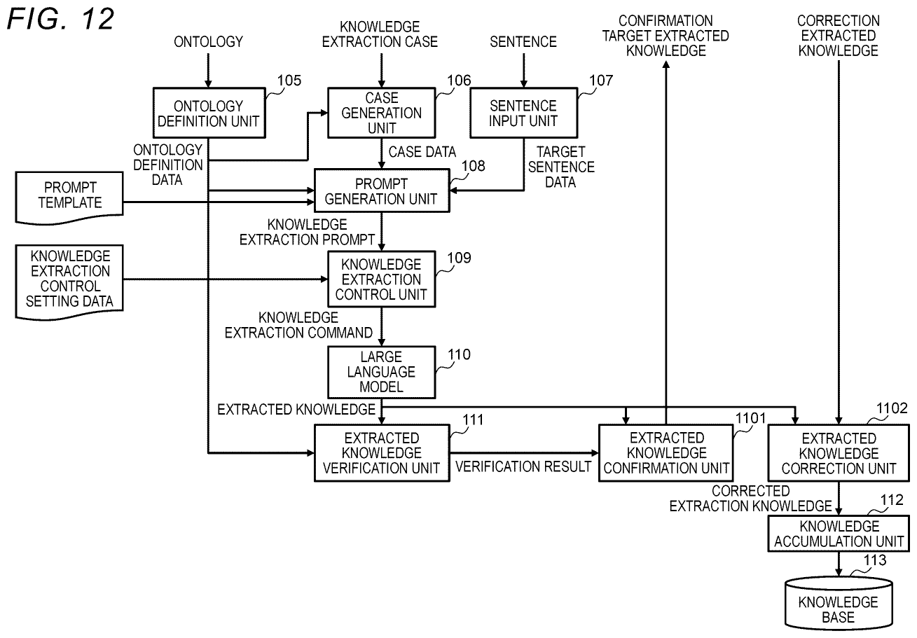

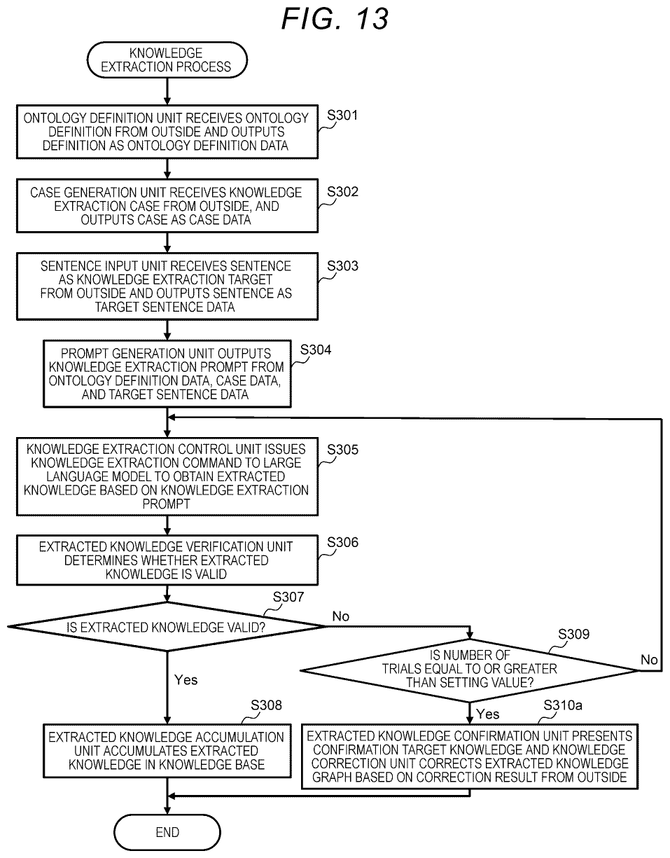

A knowledge extraction apparatus according to a second embodiment is substantially the same as the knowledge extraction apparatus 100 according to the first embodiment except for certain parts. Therefore, the configuration and operation similar to those of the knowledge extraction apparatus 100 according to the first embodiment will be omitted from description. FIG. 11 is a system configuration diagram illustrating an example of a basic configuration of a knowledge extraction apparatus 100a according to the second embodiment. FIG. 12 is a diagram illustrating an example of a flow of data according to the second embodiment. FIG. 13 is a flowchart illustrating an operation example of the knowledge extraction apparatus 100a according to the second embodiment.

In the second embodiment, the calculation processing unit 103 includes an extracted knowledge confirmation unit 1101 and an extracted knowledge correction unit 1102 in addition to the configuration of the first embodiment. In the second embodiment, the extracted knowledge verification unit 111 accepts ontology definition data and extracted knowledge as an input and outputs a verification result to the output unit 102. In the second embodiment, the verification result includes at least an identifier for determining whether the extracted knowledge is valid and a reason why the extracted knowledge is not valid when the extracted knowledge is not valid.

As the reason, for example, in the extracted knowledge graph illustrated in FIG. 10, “two or more “units” are associated with “Mass-01“ ” or “there is no chemical entity associated with “Mass-01“ ” can be exemplified.

The extracted knowledge confirmation unit 1101 accepts the extracted knowledge graph and the verification result as an input and outputs extracted knowledge that is a confirmation target (hereinafter referred to as “confirmation target extracted knowledge”) to present the extracted knowledge to the outside. The extracted knowledge confirmation unit 1101 accepts the extracted knowledge and the verification result as an input and outputs confirmation target extracted knowledge for requesting confirmation and correction. The confirmation target extracted knowledge is knowledge determined not to be valid in the extracted knowledge by the extracted knowledge verification unit 111.

The extracted knowledge correction unit 1102 receives correction knowledge for the confirmation target extracted knowledge from the outside, corrects the extracted knowledge, and outputs the corrected extracted knowledge. Specifically, the extracted knowledge correction unit 1102 accepts the extracted knowledge as an input, receives the correction knowledge from the outside, corrects the extracted knowledge based on the correction knowledge, and outputs an extracted knowledge graph based on the extracted knowledge which has been corrected (hereinafter referred to as “corrected extracted knowledge”) to the output unit 102 (step S310a). That is, in the second embodiment, a chance for the above-described correction is given instead of presenting the fact that the knowledge extraction is not appropriately executed to the outside as in the first embodiment (S310 of FIG. 7). Herein, the corrected extracted knowledge indicates a correction result of the confirmation target extracted knowledge.

In the embodiment, when the extracted knowledge verification unit 111 determines that the corrected extracted knowledge is valid, the corrected extracted knowledge is registered in the knowledge base 113 (step S308).

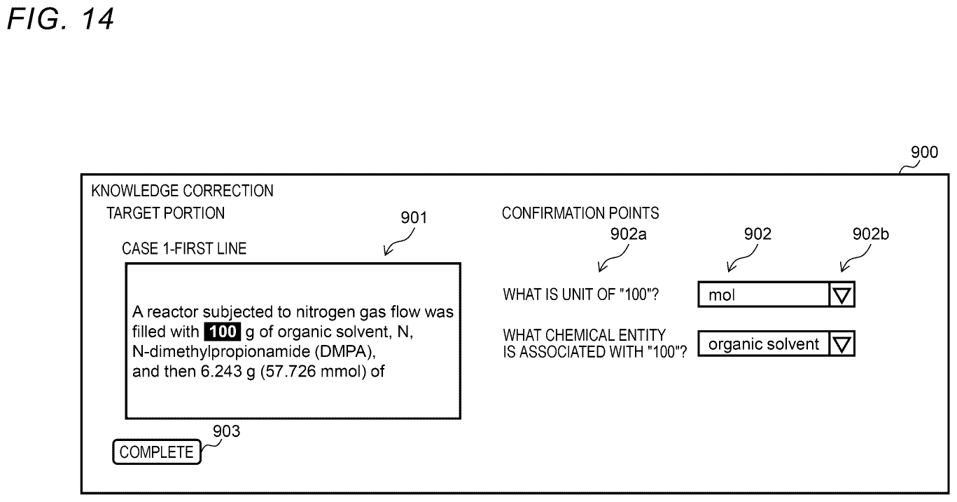

FIG. 14 is a diagram illustrating an example of a knowledge correction screen. The illustrated example is an example of a screen displayed by the extracted knowledge confirmation unit 1101 and the extracted knowledge correction unit 1102. The knowledge correction screen is displayed to present confirmation knowledge and receive correction knowledge from the outside.

The illustrated knowledge correction screen has a target portion field 901, a confirmation point field 902, and a completion button 903. In the target portion field 901, a target portion that requests a user to execute confirmation is displayed. The confirmation point field 902 includes a confirmation point 902a that request confirmation in target portion displayed in the target portion field 901 and an input field 902b for inputting correction points. In the input field 902b, classes (or instances) that should be set originally based on the ontology definition data are displayed in a pull-down menu format and any of the classes can be designed to be selected.

The completion button 903 is a button for registering a class or the like selected in the input field 902b in the knowledge base 113.

In a specific example, in the knowledge correction screen, for example, a numerical value “100” in a target sentence related to the confirmation target extracted knowledge is highlighted as a potential invalidity and is displayed as the confirmation point 902a for the user based on the verification result. The user confirms the confirmation point 902a of the confirmation point field 902 and corrects, for example, units of the numerical value “100” in the input field 902b. Then, when the completion button 903 is pressed, the corrected information is received as corrected extracted knowledge by the extracted knowledge correction unit 1102. The knowledge accumulation unit 112 stores the corrected extracted knowledge in the knowledge base 113.

Next, a flow of a knowledge extraction process according to the second embodiment will be described with reference to FIG. 13. In the knowledge extraction process illustrated in FIG. 13, an order similar to the knowledge extraction process described above with reference to FIG. 7 will not be described.

When it is not determined that the extracted knowledge is valid and the number of trials of the knowledge extraction is equal to or greater than the number of trials defined with the knowledge extraction control setting data as a result of the verification by the extracted knowledge verification unit 111, the extracted knowledge confirmation unit 1101 presents the verification target knowledge and the extracted knowledge correction unit 1102 corrects the extracted knowledge graph based on the correction result from the outside to display the corrected extracted knowledge graph on the output unit 102 (step S1307).

The knowledge extraction apparatus 100a according to the embodiment includes the extracted knowledge confirmation unit 1101 that accepts the extracted knowledge and the verification result as an input and outputs confirmation target extracted knowledge for requesting confirmation and correction and the extracted knowledge correction unit 1102 that receives correction knowledge from the outside with regard to the confirmation target extracted knowledge, corrects the extracted knowledge, and outputs the corrected extracted knowledge. In this way, since the confirmation target knowledge is output, the extracted knowledge can be corrected more simply.

The present invention is not limited to the above-described embodiments and include various modified examples and equivalent configurations within the gist of the present invention within the scope of the appended claims. For example, the above-described embodiments have been described in detail to facilitate understanding of the present invention and the present invention is not necessarily limited to those including all the above-described configurations. Elements described in parallel may also be in a form where at least one of the elements is connected in series to other elements.

The present invention can be applied to a knowledge extraction apparatus related to, for example, a technique for extracting knowledge from literatures such as patent literatures and academic papers.

What is claimed is:

1. A knowledge extraction apparatus comprising:
an ontology definition unit configured to receive definition of an ontology of a knowledge to be extracted from outside and output the definition of the ontology as ontology definition data;
a case generation unit configured to accept the ontology definition data as an input, receive a combination of a case sentence and an extracted knowledge extracted from the case sentence as a case from the outside, and output the combination as case data;
a sentence input unit configured to receive a case sentence that is a target of knowledge extraction from the outside and output the case sentence as target sentence data;
a prompt generation unit configured to accept the ontology definition data, the case data, the target sentence data, and a predetermined prompt template as an input and output a knowledge extraction prompt including the ontology definition data, the case data, the target sentence data, and the predetermined prompt template;
a knowledge extraction control unit configured to accept, as an input, the knowledge extraction prompt and knowledge extraction control setting data in which an extraction condition of the knowledge extraction is prescribed and output a knowledge extraction command to execute the knowledge extraction;
a language model configured to accept the knowledge extraction command as an input and output an extracted knowledge related to a knowledge extracted; and
a knowledge verification unit configured to accept the extracted knowledge as an input and verify validity of the extracted knowledge.

2. The knowledge extraction apparatus according to claim 1, wherein the knowledge verification unit generates an extracted knowledge graph related to the extracted knowledge and verifies the validity of the extracted knowledge.

3. The knowledge extraction apparatus according to claim 2, wherein, based on the extracted knowledge graph, the knowledge verification unit determines whether the input extracted knowledge is valid in view of definition content by the ontology definition data.

4. The knowledge extraction apparatus according to claim 1, wherein the knowledge verification unit outputs a verification result of the validity of the extracted knowledge.

5. The knowledge extraction apparatus according to claim 3, further comprising a storage unit configured to accumulate the extracted knowledge when the knowledge verification unit determines that the input extracted knowledge is valid.

6. The knowledge extraction apparatus according to claim 3, wherein the prompt generation unit includes
a conversion unit that converts data so that the language model easily processes the data, and
an information integration unit that integrates the ontology definition data, the case data, the target sentence data, and the predetermined prompt template to generate the knowledge extraction prompt.

7. The knowledge extraction apparatus according to claim 3,
wherein the ontology definition data includes at least one class that is an element included in the extracted knowledge and a property indicating an attribute to be taken by the class, and
wherein the knowledge verification unit verifies the validity of the extracted knowledge in accordance with whether the class is consistent with the property.

8. The knowledge extraction apparatus according to claim 3,
wherein the ontology definition data includes at least one class that is an element included in the extracted knowledge and an instance to correspond to the class, and
wherein the knowledge verification unit verifies validity of the extracted knowledge in accordance with whether the class corresponds to the instance.

9. The knowledge extraction apparatus according to claim 4, further comprising:
a knowledge confirmation unit configured to accept the extracted knowledge and the verification result as an input and output confirmation target knowledge for requesting confirmation and correction; and
a knowledge correction unit configured to receive correction knowledge from the outside with regard to the confirmation target knowledge, correct the extracted knowledge, and output the corrected extracted knowledge.

10. A knowledge extraction method comprising:
an ontology definition step in which an ontology definition unit receives definition of an ontology of a knowledge to be extracted from outside and outputs the definition of the ontology as ontology definition data;
a case generation step in which a case generation unit accepts the ontology definition data as an input, receives a combination of a case sentence and an extracted knowledge extracted from the case sentence as a case from the outside, and outputs the combination as case data;
a sentence input step in which a sentence input unit receives a case sentence that is a target of knowledge extraction from the outside and outputs the case sentence as target sentence data;
a prompt generation step in which a prompt generation unit accepts the ontology definition data, the case data, the target sentence data, and a predetermined prompt template as an input and outputs a knowledge extraction prompt including the ontology definition data, the case data, the target sentence data, and the predetermined prompt template;
a knowledge extraction control step in which a knowledge extraction control unit accepts, as an input, the knowledge extraction prompt and knowledge extraction control setting data in which an extraction condition of the knowledge extraction is prescribed and outputs a knowledge extraction command to execute the knowledge extraction; and
a knowledge verification step in which a knowledge verification unit accepts the knowledge extraction command as an input using a language model, and outputs an extracted knowledge related to a knowledge extracted, and verifies validity of the extracted knowledge.
